(19) United States
(12) Patent Application Publication
(10) Pub. No.: US 2015/0044379 A1
(43) Pub. Date: Feb. 12, 2015

(54) METHOD FOR PRODUCING RUBBER ROLLER AND RUBBER COMPOSITION

(71) Applicant: FUJI XEROX CO., LTD., Tokyo (JP)

(72) Inventor: Eiichi IIDA, Kanagawa (JP)

(73) Assignee: FUJI XEROX CO., LTD., Tokyo (JP)

(21) Appl. No.: 14/451,999

(22) Filed: Aug. 5, 2014

(30) Foreign Application Priority Data
Aug. 9, 2013 (JP) 2013-166374

(51) Int. Cl. C08J 7/04; B05D 3/00

(52) U.S. Cl. CPC C08J 7/047; B05D 3/007; C08J 2315/02
USPC 427/377; 524/612

(57) ABSTRACT

A method for producing a rubber roller includes preparing a rubber composition containing epichlorohydrin rubber and a conductive agent, the epichlorohydrin rubber being an epichlorohydrin-ethylene oxide-allyl glycidyl ether ternary copolymer that contains an ethylene oxide-derived structural unit within a range of 40 mol % or more and 60 mol % or less relative to the entire ternary copolymer, and a content of calcium oxide being 1 part by weight or less relative to 100 parts by weight of the epichlorohydrin rubber; removing a volatile component so that a ratio of the volatile component contained in the rubber composition is 0.8% by weight or less relative to the entire rubber composition; coating a periphery of a core body with the rubber composition to form a rubber composition layer; and vulcanizing the rubber composition layer under atmospheric pressure to form a rubber layer on the periphery of the core body.

### CROSS-REFERENCE TO RELATED APPLICATIONS

This application is based on and claims priority under 35 USC 119 from Japanese Patent Application No. 2013-166374 filed Aug. 9, 2013.

### BACKGROUND

### Technical Field

The present invention relates to a method for producing a rubber roller and a rubber composition.

### SUMMARY

According to an aspect of the invention, there is provided a method for producing a rubber roller. The method includes preparing a rubber composition containing epichlorohydrin rubber and a conductive agent, the epichlorohydrin rubber being an epichlorohydrin-ethylene oxide-allyl glycidyl ether ternary copolymer that contains an ethylene oxide-derived structural unit within a range of 40 mol % or more and 60 mol % or less relative to the entire ternary copolymer, and a content of calcium oxide being 1 part by weight or less relative to 100 parts by weight of the epichlorohydrin rubber; removing a volatile component so that a ratio of the volatile component contained in the rubber composition is 0.8% by weight or less relative to the entire rubber composition; molding a periphery of a core body with the rubber composition having the volatile component ratio of 0.8% by weight or less to form a rubber composition layer; and vulcanizing the rubber composition layer under atmospheric pressure to form a rubber layer on the periphery of the core body.

### BRIEF DESCRIPTION OF THE DRAWINGS

Exemplary embodiments of the present invention will be described in detail based on the following figures, wherein:

FIG. 1 is a schematic sectional view illustrating an example of a closed kneading machine provided with a vent used in a method for producing a rubber roller according to an exemplary embodiment of the present invention;

FIG. 2 is a schematic sectional view illustrating another example of a closed kneading machine provided with a vent used in a method for producing a rubber roller according to an exemplary embodiment of the present invention; and

FIG. 3 is a schematic sectional view illustrating an example of a kneading extrusion molding machine provided with a vent used in a method for producing a rubber roller according to an exemplary embodiment of the present invention.

### DETAILED DESCRIPTION

An exemplary embodiment of the present invention is described in detail below.

### [Method for Producing Rubber Roller]

A method for producing a rubber roller according to an exemplary embodiment of the present invention includes preparing a rubber composition containing epichlorohydrin rubber and a conductive agent, the epichlorohydrin rubber being an epichlorohydrin-ethylene oxide-allyl glycidyl ether ternary copolymer that contains an ethylene oxide-derived structural unit within a range of 40 mol % or more and 60 mol % or less relative to the entire ternary copolymer, and a content of calcium oxide (may be referred to as an “amount of calcium oxide” hereinafter) being 1 part by weight or less relative to 100 parts by weight of the epichlorohydrin rubber; removing a volatile component so that a ratio of the volatile component contained in the rubber composition is 0.8% by weight or less relative to the entire rubber composition; coating the outer periphery of a core body with the rubber composition having a volatile component ratio of 0.8% by weight or less to form a rubber composition layer; and vulcanizing the rubber composition layer under atmospheric pressure to form a rubber layer on the periphery of the core body.

A rubber roller including the rubber layer formed as an elastic layer on the periphery of the core body is produced as described above.

Hereinafter, the ratio of the volatile component relative to the entire rubber composition may be referred to as the “amount of the volatile component”.

The method for producing a rubber roller according to the exemplary embodiment of the present invention produces the rubber roller in which outer diameter growth due to moisture absorption of the rubber layer over time is suppressed while foaming during vulcanization of the rubber composition is suppressed, as compared with the case where the removal of the volatile component is not performed, the case where the removal of the volatile component is performed, but the amount of the volatile component is larger than the above-described range, or the case where the content of calcium oxide is larger than the above-described range.

The reason for this is not certain but is supposed as described below.

When the rubber composition layer is vulcanized under atmospheric pressure according to the exemplary embodiment of the present invention, it is difficult to suppress expansion of moisture contained in the rubber composition layer as compared with, for example, the case using a mold. Therefore, when the rubber composition layer has a high moisture content, it is considered to be difficult to control surface quality because foaming is caused by moisture expansion during vulcanization.

In addition, according to the exemplary embodiment of the present invention, the epichlorohydrin rubber that is an epichlorohydrin-ethylene oxide-allyl glycidyl ether ternary copolymer is used as a material of the rubber composition. With the epichlorohydrin rubber having a higher ratio of an ethylene oxide-derived structural unit (may be referred to as a “ratio of ethylene oxide” hereinafter) in the ternary copolymer, the rubber roller having low electric resistance is produced, but foaming due to moisture is considered to easily occur during vulcanization because of high moisture absorption. For example, by using the epichlorohydrin rubber having the ratio of ethylene oxide within the above-described range according to the exemplary embodiment of the present invention, the rubber roller having low electric resistance is produced, but moisture absorption by the epichlorohydrin rubber easily occurs, as compared with the case where the ratio of ethylene oxide is lower than the above-described range.

On the other hand, when the epichlorohydrin rubber having the ratio of ethylene oxide within the above-described range is used, a conceivable method for suppressing the foaming is to add calcium oxide to adsorb moisture on calcium oxide. However, when foaming is suppressed by adding a large amount of calcium oxide, calcium oxide contained in the rubber layer of the resultant rubber roller absorbs moisture, and thus surface smoothness of the rubber roller may be degraded or the outer diameter of the rubber roller may be increased by outer diameter growth over time.

However, in the exemplary embodiment of the invention, the epichlorohydrin having the ratio of ethylene oxide of 40 mol % or more and 60 mol % or less is used and coating of the core body and vulcanization are performed after the amount of the volatile component is brought within the above-described range by removing the volatile component.

Therefore, even when the amount of calcium oxide is 1 part by weight or less, foaming due to moisture expansion is considered to be suppressed during vulcanization because of a lower moisture content in the rubber composition layer.

Therefore, it is considered that in the exemplary embodiment of the invention, the rubber roller causes little deterioration of smoothness and outer diameter growth due to moisture absorption because the amount of calcium oxide is within the above-described range.

As described above, in the exemplary embodiment of the invention, foaming during vulcanization is thought to be suppressed as compared with the case where the removal of the volatile component is not performed or the case where even when the removal of the volatile component is performed, coating of the core body and vulcanization are performed under a condition where the amount of the volatile component is larger than the above-described range. Also, it is considered that in the exemplary embodiment of the invention, the rubber roller in which the outer diameter growth due to moisture absorption of the rubber layer is suppressed can be produced as compared with the case where the amount of calcium oxide is larger than the above-described range.

Therefore, in the exemplary embodiment of the invention, outer diameter growth due to moisture absorption is suppressed while foaming is suppressed during vulcanization even when vulcanization is performed under atmospheric pressure, thereby producing the rubber roller with controlled surface quality without shape correction using a mold or a grinder.

In particular, when an ionic conductive agent is used as a conductive agent, with an excessive amount of calcium oxide, calcium oxide contained in the rubber layer of the resultant rubber roller reacts with the ionic conductive agent, thereby possibly increasing the electric resistance over time. On the other hand, in the exemplary embodiment of the invention, the amount of calcium oxide is within the above-described range, and thus an increase in electric resistance over time is thought to be suppressed. In addition, it is thought that as described above, in the exemplary embodiment of the invention, the ratio of ethylene oxide is within the above-described range, and thus the rubber roller with low electric resistance can be produced, and the low electric resistance is maintained over time as compared with the case where the ratio of ethylene oxide is lower than the above-described range.

Here, the term “volatile component” represents, for example, moisture, air, or the like, and specifically represents a component that is gaseous at 140° C. under atmospheric pressure.

The amount of volatile component is desired to be 0.8% by weight or less and more desired to be 0.5% by weight or less, and is desired to be as small as possible. In addition, the amount of volatile component is desired to be 0% by weight.

A method for measuring the amount of volatile component in the rubber composition undergoing the removal of the volatile component is, for example, a method below.

Specifically, the amount of volatile component can be determined using a method of measuring a reduction in amount of the volatile component by heat-drying the rubber composition.

Each of the operations of the method for producing a rubber roller according to the exemplary embodiment of the invention is described below.

### <Preparation of Rubber Composition>

In preparing the rubber composition, the rubber composition containing epichlorohydrin rubber and a conductive agent is prepared, the epichlorohydrin rubber being an epichlorohydrin-ethylene oxide-allyl glycidyl ether ternary copolymer containing an ethylene oxide-derived structural unit within a range of 40 mol % or more and 60 mol % or less, and a content of calcium oxide being 1 part by weight or more relative to 100 parts by weight of the epichlorohydrin rubber.

Specifically, raw materials of the rubber composition described below are kneaded by using, for example, a closed-type mixer and an open roll, preparing an unvulcanized rubber composition.

The method for preparing the rubber composition is not particularly limited as long as it is a method for producing the rubber composition including a mixture of the raw materials below.

The raw materials of the rubber composition are described below.

### —Epichlorohydrin Rubber—

As described above, the epichlorohydrin rubber used in the exemplary embodiment of the invention is an epichlorohydrin-ethylene oxide-allyl glycidyl ether ternary copolymer.

The ratio of ethylene oxide is 40 mol % or more and 60 mol % or less.

With the ratio of ethylene oxide being within the above-described range, the rubber roller having a low electric resistance value is produced as compared with the case where the ratio of ethylene oxide is lower than the range. Also, with the ratio of ethylene oxide being within the above-described range, the suppression of foaming during vulcanization is easily realized with calcium oxide in an amount of 1 part by weight or less, and outer diameter growth due to moisture absorption of the epichlorohydrin rubber over time is suppressed, as compared with the case where the ratio of ethylene oxide is higher than the range.

### —Conductive Agent—

As described above, the rubber composition contains the conductive agent.

Examples of the conductive agent include an electronic conductive agent and an ionic conductive agent.

Examples of the electronic conductive agent include powders of carbon black such as Ketjenblack, acetylene black, and the like; pyrolytic carbon; graphite; various conductive metals or alloys such as aluminum, copper, nickel, stainless steel, and the like; various conductive metal oxides such as tin oxide, indium oxide, titanium oxide, tin oxide-antimony oxide solid solution, tin oxide-indium oxide solid solution, and the like; insulating materials subjected to surface conductive treatment; and the like.

Examples of the ionic conductive agent include perchlorates and chlorates of tetraethylammonium, lauryl trimethylammonium, and the like; and perchlorates and chlorates of alkali metals and alkaline earth metals such as lithium, magnesium, and the like.

These conductive agents may be used alone or in combination of two or more.

The amount of the conductive agent added is not particularly limited but, for example, when the electronic conductive agent is used as the conductive agent, the amount is, for example, within a range of 1 part by weight or more and 80 parts by weight or less and may be within a range of 15 parts by weight or more and 80 parts by weight or less relative to 100 parts by weight of the epichlorohydrin rubber.

Also, for example, when the ionic conductive agent is used as the conductive agent, the amount of the conductive agent added is, for example, within a range of 0.1 parts by weight or more and 5.0 parts by weight or less and may be within a range of 0.5 parts by weight or more and 3.0 parts by weight or less relative to 100 parts by weight of the epichlorohydrin rubber.

### —Other Additives—

If required, the rubber composition may contain other additives in addition to the epichlorohydrin rubber and the conductive agent.

As described above, in the exemplary embodiment of the invention, the amount of calcium oxide is 1 part by weight or less. That is, the rubber composition may not contain calcium oxide or may contain calcium oxide in an amount of 1 part by weight or less relative to 100 parts by weight of the epichlorohydrin rubber. Unlike in the case where the amount of calcium oxide is larger than the above-described range, calcium oxide in an amount of 1 part by weight or less little causes the deterioration of smoothness, the outer diameter growth, and an increase in electric resistance, etc. due to moisture absorption by calcium oxide over time.

Also, in the exemplary embodiment of the invention, from the viewpoint of suppressing foaming during vulcanization, it is desirable not to positively add a foaming agent to the rubber composition, and the rubber composition desirably contains no foaming agent other than water.

Examples of other additives include materials that are generally added to a rubber layer, such as an inorganic filler, a softener, a plasticizer, a curing agent, a vulcanizing agent, a vulcanization accelerator, an antioxidant, a surfactant, a coupling agent, and the like.

Examples of the vulcanizing agent include vulcanizing agents that liberate a halogen group to bring about vulcanization, such as sulfur, 2,4,6-trimercapto-s-triazine, 6-methylquinoxaline-2,3-dithiocarbamate, and the like. These may be used alone or in combination of two or more.

Examples of the vulcanization accelerator include thiazole-based, sulfenamide-based, thiuram-based, and dicarbamate-based accelerators, xanthates, and the like. These may be used alone or in combination of two or more. Besides these, known rubber compounding materials such as zinc oxide, stearic acid, and the like may be added. These may be used alone or in combination of two or more.

### <Removal of Volatile Component>

In removing a volatile component, the volatile component contained in the rubber composition prepared is removed so that the amount of the volatile component is within the above-described range, thereby producing an unvulcanized rubber composition with the amount of the volatile component being within the above-described range.

The method for removing the volatile component is not particularly limited as long as the amount of the volatile component is brought within the above-described range.

A specific example of the method for removing the volatile component is a method of kneading the rubber composition by using a closed kneading machine provided with a vent and venting the volatile component contained in the rubber composition from the vent to remove the volatile component (may be referred to as the “method using a closed kneading machine provided with a vent” hereinafter). Another example of the method for removing the volatile component is a method of placing the rubber composition in a closed vessel and evacuating the vessel to remove the volatile component contained in the rubber composition by suction from the surface of the rubber composition (may be referred to as the “method of evacuating a closed vessel” hereinafter). These methods may be used alone or in combination so that the amount of the volatile component is within the above-described range.

Each of the method using a closed kneading machine provided with a vent and the method of evacuating a closed vessel is described in detail below.

—Method Using a Closed Kneading Machine Provided with a Vent—

First, the method using a closed kneading machine provided with a vent is described.

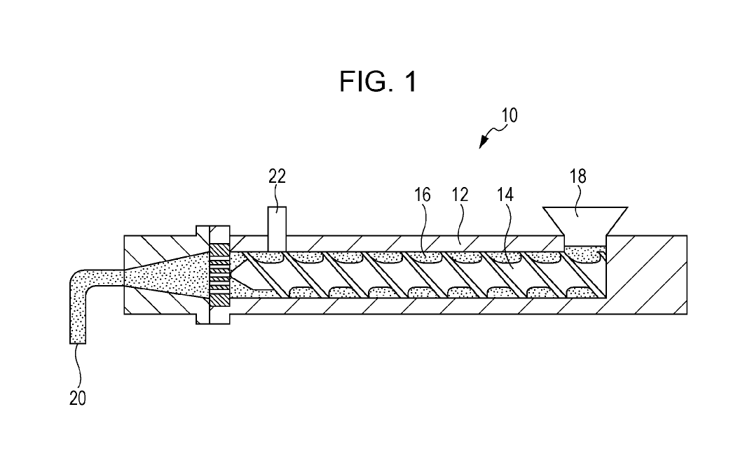

FIG. 1 is a schematic sectional view illustrating a closed kneading machine including a vent provided on the outlet port side of a cylinder as an example of a closed kneading machine with a vent.

A kneading machine 10 illustrated in FIG. 1 includes a screw 14 provided in a cylindrical cylinder 12 serving as a body. An inlet 18 through which a rubber composition 16 is charged is provided at one of the ends of the cylinder 12, and an outlet 20 through which the rubber composition 16 is discharged is provided at the other end of the cylinder 12.

Also, a vent 22 serving as a vent port for venting the volatile component contained in the rubber composition 16 to the air is provided on the outlet 20 side of the cylinder 12. Although not shown in the drawing, a dam is provided on the screw 14 so as to thinly spread the rubber composition 16 delivered, and the vent 22 is provided immediately behind the dam (downstream side in the extrusion direction of the rubber composition 16).

In the kneading machine 10 illustrated in FIG. 1, the vent 22 is open to the air, but if required, the vent 22 may be connected to a pressure reducing apparatus. Also, if required, the vent 22 may be provided with a valve that cuts off the cylinder 12 from the air or the pressure reducing apparatus so that the volatile component is vented by opening the valve.

In the kneading machine 10 illustrated in FIG. 1, first the rubber composition 16 is charged in the cylinder 12 of the kneading machine 10 through the inlet 18. Then, for example, the cylinder 12 is controlled by a heating device (not shown) to a temperature where the rubber composition 16 softens to a viscosity that allows the rubber composition 16 to be easily properly processed, and the screw 14 is rotationally driven by a driving motor (not shown). Therefore, the rubber composition 16 charged through the inlet 18 is softened inside the cylinder 12 and delivered to the outlet port 20 while being kneaded by the screw 14. In addition, the volatile component contained in the rubber composition 16 is gasified by softening and kneading the rubber composition 16 and vented to the air through the vent 22.

The temperature of the cylinder 12 for softening and kneading the rubber composition 16 by the kneading machine 10 is, for example, 60° C. or more and 110° C. or less.

The time required for extrusion of the rubber composition 16 by the kneading machine 10 is, for example, 5 minutes or more and 30 minutes or less. The rotational speed of the screw 14 is, for example, 5 rpm or more and 40 rpm or less, the inner diameter of the screw 14 is, for example, 30 mm or more and 90 mm or less, and the ratio of length of the screw 14 to the inner diameter of the cylinder 12 is, for example, 8 or more and 22 or less.

When the kneading machine 10 illustrated in FIG. 1 is used, in order to bring the amount of volatile component within the above-described range, it is desired to repeat two times the operation of charging the rubber composition 16 through the inlet 18, kneading the rubber composition 16 in the cylinder 12, and venting the volatile component through the vent 22. That is, it is desired that the rubber composition 16 discharged from the outlet port 20 after the volatile component is removed by the kneading machine 10 provided with the vent 22 is further charged in the cylinder 12 from the inlet 18 of the kneading machine 10 and kneaded and the volatile component is vented through the vent 22. The number of repeats of the venting operation of removing the volatile component with the kneading machine 10 (may be referred to as the “number of venting operations” hereinafter) is 2 or more.

The number of the venting operations required for bringing the amount of volatile component within the above-described range depends on the composition of the rubber composition 16 and conditions for extrusion of the rubber composition 16 by the kneading machine 10. When the rubber composition 16 having the above-described composition is extruded under, for example, the above-described conditions, it is considered to be difficult to bring the amount of volatile component within the above-described range by one venting operation. Therefore, the number of the venting operations is, for example, 2 or more and more desirably 2 or more and 3 or less.

In two or more venting operations, one kneading machine may be used two or more times or two or more kneading machines may be combined.

When the number of the venting operations is 2 or more, for example, after the first venting operation, the second venting operation may be performed after the rubber composition 16 is shaped by using an open roll or the like into a form that can be easily charged into the kneading machine 10.

However, in the exemplary embodiment of the invention, in order to bring the amount of the volatile component within the range described above by removing the volatile component, it is desirable to avoid the rubber composition from absorbing moisture between the venting operations. A specific example of a method for avoiding the rubber composition from absorbing moisture is a method of controlling a time of contact between the rubber composition and the outside air to less than 24 hours by performing the second venting operation after storing, in a closed vessel, the rubber composition undergoing the first venting operation. Also, for example, the two or more venting operations may be performed as a series of operations by using two or more kneading machines and piping so that the rubber composition 16 is delivered from the outlet 20 of a kneading machine 10 to the inlet 18 of another kneading machine 10 with no contact with the outside air.

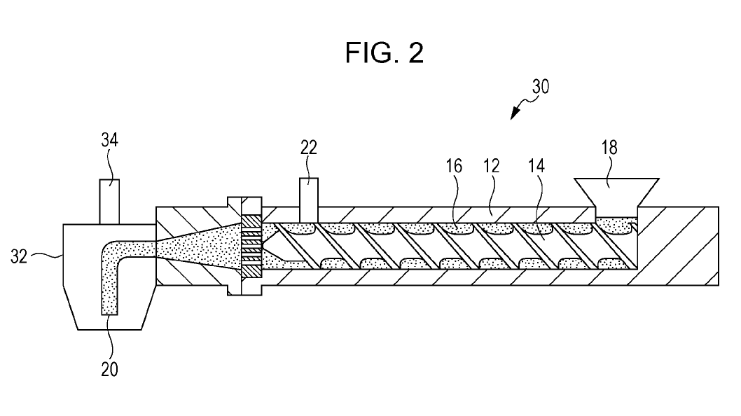

Further, a kneading machine having two or more vents as illustrated in FIG. 2 may be used instead of the kneading machine 10 illustrated in FIG. 1.

A kneading machine 30 illustrated in FIG. 2 is the same as the kneading machine 10 illustrated in FIG. 1 except that a housing 32 is provided to surround the periphery of the outlet 20 through which the rubber composition 16 is discharged from the kneading machine 30 and the housing 32 is provided with a vent 34 serving as a vent port for venting the volatile component contained in the rubber composition 16 to the air.

The amount of volatile component can be more easily brought within the above-described range by using a kneading machine with two or more vents.

### —Method of Evacuating Closed Vessel—

Next, described is the method of placing the rubber composition in a closed vessel and evacuating the closed vessel to remove the volatile component contained in the rubber composition by suction from the surface of the rubber composition (method of evacuating a closed vessel).

When the method of evacuating a closed vessel is used, it is desirable to place the rubber composition in the closed vessel after finely cutting the rubber composition and then evacuating the closed vessel, thereby removing the volatile component by suction from the surfaces of fragments of the rubber composition.

A method for finely cutting the rubber composition is, for example, a method using a pelletizer or the like.

When the amount of the volatile component is brought within the above-described range by the method of evacuating a closed vessel, a desired size of the finely cut rubber composition is, for example, a 2-cm square or less from the viewpoint of facilitating removal of the volatile component contained in the rubber composition.

A degree of vacuum (pressure) for evacuation is, for example, 100 hPa or less from the viewpoint of bringing the amount of the volatile component with the above-described range. Also, a time required for evacuation is, for example, 3 minutes or more for 100 g of the rubber composition.

<Coating of Periphery of Core Body with Rubber Composition>

In coating a periphery of a core body with the rubber composition, the periphery of the core body is coated with the unvulcanized rubber composition having the amount of volatile component brought within the above-described range by removing the volatile component, thereby forming a rubber composition layer on the periphery of the core body.

That is, the periphery of the core body is coated with the rubber composition having the amount of volatile component maintained within the above-described range by removing the volatile component so that the amount of volatile component is brought within the above-described range by removing the volatile component.

A specific method for coating the periphery of the core body with the rubber composition having the amount of volatile component maintained within the above-described range is not particularly limited. Specifically, for example, after removal of the volatile component, the rubber composition is taken out from an apparatus used for removing the volatile component, and the core body is coated with the rubber composition. When a time (for example, 24 hours or more) is required up to coating the core body with the rubber composition after the rubber composition is taken out from an apparatus used for removing the volatile component, the amount of volatile component may be maintained within the above-described range by storing, in a closed vessel, the rubber composition taken out.

In addition, for example, removal of the volatile component and coating with the rubber composition may be continuously performed as a series of operations so that the periphery of the core body is coated with the rubber composition under a condition in which the rubber composition from which the volatile component has been removed is out of contact with the outside air.

A method for coating the periphery of the core body with the rubber composition without contact between the rubber composition and the outside air after removing the volatile component is, for example, a method using a kneading extrusion molding apparatus provided with a vent (may be referred to as a “vented extrusion molding apparatus” hereinafter).

That is, in removing the volatile component, the operation (the venting operation) of removing the volatile component is performed plural times, and the final operation among the plural operations is performed inside the vented extrusion molding apparatus.

Specifically, for example, the volatile component is removed from the rubber composition by using the closed kneading machine provided with the vent, and then further removal of the volatile component and coating of the core body with the rubber composition are continuously performed using the vented extrusion molding apparatus. In addition, for example, the volatile component may be removed from the rubber composition by evacuating the closed vessel, and then further removal of the volatile component and coating of the core body with the rubber composition may be continuously performed using the vented extrusion molding apparatus.

When the vented extrusion molding apparatus is used as described above, the amount of volatile component may be within the above-described range after the volatile component is removed from the rubber composition in a kneading extrusion portion provided in the vented extrusion molding apparatus. That is, even when the amount of volatile component is larger than the above-described range after the volatile component is removed by the closed kneading machine with the vent or by evacuating the closed vessel and before the rubber composition is charged in the vented extrusion molding apparatus, the amount of volatile component may be within the above-described range in a stage where the volatile component has been removed from the rubber composition in the kneading extrusion portion provided in the vented extrusion molding apparatus (that is, in a stage where removal of the volatile component is completed).

—Vented Extrusion Molding Apparatus (Kneading Extrusion Molding Apparatus with Vent)—

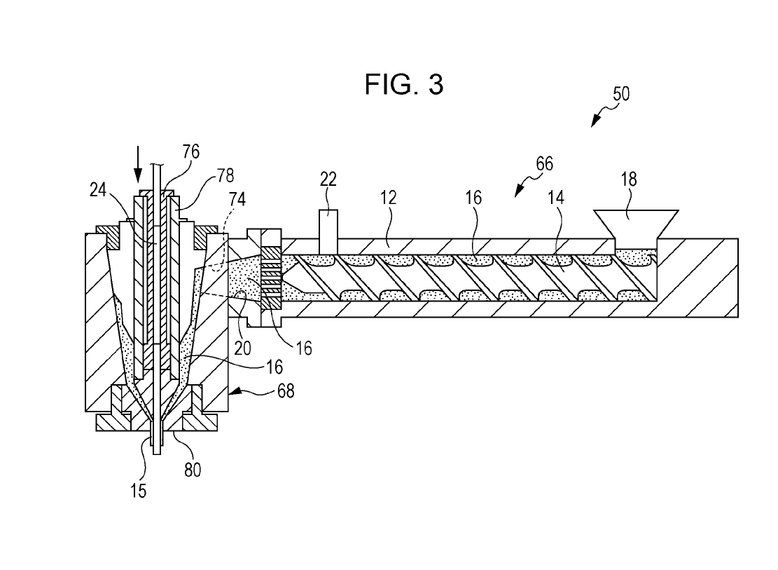

FIG. 3 is a schematic sectional view illustrating an example of the vented extrusion molding apparatus. The same members as in the kneading machine illustrated in FIG. 1 are denoted by the same reference numerals and are not described below.

A vented extrusion molding apparatus 50 illustrated in FIG. 3 is a uniaxial extrusion molding apparatus for rubber, including a kneading extrusion portion 66 and a crosshead die 68.

The kneading extrusion portion 66 includes, like in the kneading machine 10, a cylindrical cylinder 12 having a screw 14 provided therein, an inlet 18 provided at one of the ends of the cylinder 12, an outlet 20 provided at the other end, and a vent 22 provided on the outlet 20 side of the cylinder 12.

The crosshead die 68 is connected to the outlet 20 of the kneading extrusion portion 66 so that the rubber composition 16 is caused to flow in the crosshead die 68 in a direction crossing the extrusion direction of the kneading extrusion portion 66. In this case, the crosshead die 68 is disposed so that the rubber composition 16 charged in the inlet 18 of the kneading extrusion portion 66 is plasticized by the screw 14 in the cylinder 12 provided perpendicularly to the gravity direction and is extruded from the kneading extrusion portion 66, and then the plasticized rubber composition 16 falls in the gravity direction.

The crosshead die 68 has a conical internal shape in which an apex side is located at a lower portion in the gravity direction, and an inlet port 74 is formed in the periphery to be connected to the outlet 20 of the kneading extrusion portion 66. Also, a cylindrical core body holder 76 is provided in a central portion of the crosshead die 68 so as to hold the peripheral surface of a core body 24.

A guide cylinder 78 is provided outside the core body holder 76. The guide cylinder 78 guides the rubber composition 16 flowing through the inlet port 74.

In addition, a die 80 is provided on the outlet side of the crosshead die 68. The die 80 functions to pressure-bond the core body 24 and the rubber composition 16 and to control the outer diameter dimension, forming an unvulcanized rubber composition layer 15.

In the vented extrusion molding apparatus 50 configured as described above, the rubber composition 16 is extruded using the screw 14 provided in the cylinder 12 of the kneading extrusion portion 66, and at the same time, the core body 24 is supplied to the crosshead die 68 and passed through the crosshead die 68. Consequently, the unvulcanized rubber composition layer 15 of the rubber composition 16 is formed on the peripheral surface of the core body 24.

The core body 24 with the periphery surface on which the unvulcanized rubber composition layer 15 has been formed is discharged through the die 80 and then cut.

### —Core Body—

The core body 24 used for coating may function as a support member of the rubber roller and also may function as an electrode when the rubber roller is used as a charging roller.

The shape of the core body 24 is, for example, a columnar shape or a cylindrical shape.

Examples of a material that constitutes the core body 24 include metals such as iron (free-machining steel), stainless steel, aluminum, copper, brass, nickel, and the like.

Also, the core body 24 may be, for example, a resin or ceramic member having an outer surface plated with the above-described material or a resin or plastic member on which a conductive agent is dispersed.

In the exemplary embodiment of the invention, when the amount of the volatile component in the rubber composition used in coating the periphery of the core body is within the above-described range, the vented extrusion molding machine may not be used. Specifically, after the volatile component is removed, the periphery of the core body may be coated by using an extrusion molding machine without a vent while the amount of the volatile component is maintained in the above-described range by, for example, a method of storing in a closed vessel or the like.

### <Vulcanization Under Atmospheric Pressure>

In vulcanization under atmospheric pressure, the rubber composition (unvulcanized rubber composition layer) that coats the periphery of the core body is vulcanized under atmospheric pressure to form a rubber layer. Specifically, vulcanization is performed by heating with, for example, an oven, a microwave irradiation device, an ultraviolet irradiation device, a hot-air generator, a high-frequency heating device, or the like. Therefore, vulcanization is performed without filling a mold with the rubber composition or positively applying pressure. That is, the unvulcanized rubber composition layer that coats the periphery of the core body is irradiated with infrared light, microwaves, ultraviolet light, hot air, or the like so that vulcanization is performed in non-contact with the peripheral surface of the rubber composition layer.

Here, “under atmospheric pressure” represents the above-described condition where pressure is not positively applied, for example, a condition under substantially atmospheric pressure.

As described above, the rubber composition that coats the periphery of the core body is vulcanized under atmospheric pressure to produce a rubber roller including the rubber layer provided on the periphery of the core body.

The rubber roller produced by the method for producing a rubber roller according to the exemplary embodiment of the invention may be used as a charging roller, a transfer roller, or the like of an image forming apparatus, and a transport roller other than an image forming apparatus.

As described above, the rubber roller produced by the method for producing a rubber roller according to the exemplary embodiment of the invention has, in addition to a suppressed electric resistance, suppressed foaming during vulcanization, and thus has good surface smoothness without shape correction using a grinder or the like and causes little outer diameter growth over time. Therefore, in particular, when the rubber roller is used as a charging roller, a transfer roller, or the like of an image forming apparatus, the rubber roller causes little deterioration of an image due to surface unevenness of the roller and little change in image quality over time due to outer diameter growth over time. Even when the rubber roller is used as a transport roller, the rubber roller little causes transport defects due to surface unevenness of the roller and outer diameter growth over time.

### Examples

The invention is described in detail below with reference to examples, but the invention is not limited to the examples below. Hereinafter, “parts” and “%” are on a weight basis unless otherwise specified.

### [Formation of Rubber Roller]

### <Rubber Roller 1>

(Preparation of Rubber composition 1)

A mixture having a composition described below is kneaded with a closed mixer and an open roll to prepare unvulcanized rubber composition 1. The amount of calcium oxide in the rubber composition 1 is 0 part by weight.

### —Composition—

Epichlorohydrin rubber: 100 parts by weight

(trade name: Epion 301, manufactured by Daiso Co., Ltd., ratio of ethylene oxide: 59 mol %)
Ionic conductive agent: 2 parts by weight

(quaternary ammonium salt, trade name: KS-555, manufactured by Kao Corporation)
Zinc oxide (zinc oxide JIS#2: manufactured by Hakusui Tech Co., Ltd.): 5 parts by weight
Stearic acid (stearic acid S: manufactured by Kao Corporation): 1 part by weight
Inorganic filler
   Carbon black (trade name: #3030B, manufactured by Mitsubishi Chemical Corporation): 5 parts by weight
   Calcium carbonate (Whiton SSB, manufactured by Shiraishi Kogyo Kaisha, Ltd.): 20 parts by weight
Vulcanizing agent (sulfur: Sulfux 200S, manufactured by Tsurumi Chemical Co., Ltd.): 1 part by weight
Vulcanization accelerator: 1 part by weight

(dibenzothiazyl sulfide, trade name: Nocceler DM, manufactured by Ouchi-Shinko Chemical Co., Ltd.)
Vulcanization accelerator: 1 part by weight

(tetramethylthiuram monosulfide, trade name: Nocceler TS, manufactured by Ouchi-Shinko Chemical Industrial Co., Ltd.)

### (Removal of Volatile Component and Coating of Core Body)

The resultant rubber composition 1 is charged in the kneading machine 10 (a closed kneading machine with a vent) illustrated in FIG. 1, and the volatile component is removed. The temperature of the cylinder 12 in the kneading machine 10 is 80° C., the extrusion time is 20 minutes, the rotational speed of the screw 14 is 20 rpm, the inner diameter of the screw 14 is 50 mm, and the length of the screw 14 is 800 mm.

The rubber composition 1 discharged from the kneading machine 10 illustrated in FIG. 1 is further charged in the vented extrusion molding apparatus 50 (kneading extrusion molding apparatus with a vent) illustrated in FIG. 3, and removal of the volatile component and coating of the core body are performed by a series of operations, forming an unvulcanized rubber composition layer 1 composed of the rubber composition 1 on the periphery of the core body.

A columnar member having a diameter of 8 mm and a length of 330 mm and including free-machining steel as a material is used as the core body. The temperature of the cylinder 12 in the vented extrusion molding apparatus 50 is 60° C., the extrusion time is 10 minutes, the rotational speed of the screw 14 is 15 rpm, the diameter of the screw 14 is 50 mm, and the length of the screw 14 is 800 mm.

### (Vulcanization of Rubber Composition Layer)

The unvulcanized rubber composition layer 1 formed on the periphery of the core body is vulcanized with a gear oven (Perfect Oven manufactured by Espec CORP.) at 180° C. for 30 minutes under atmospheric pressure. As a result, a rubber roller 1 including a rubber layer 1 formed on the core body is produced.

### <Rubber Roller 2>

### (Preparation of Rubber Composition 2)

A rubber composition 2 is prepared by the same method as for the rubber composition 1 except that epichlorohydrin rubber (trade name: DG, manufactured by Daiso Co., Ltd., ratio of ethylene oxide: 42 mol %) is used as the epichlorohydrin rubber, and 1 part by weight of calcium oxide is added.

### (Removal of Volatile Component, Coating of Core Body, and Vulcanization of Rubber Composition Layer)

A rubber roller 2 is produced by the same method as for the rubber roller 1 except that the rubber composition 2 is used in place of the rubber composition 1.

### <Rubber Roller 3>

### (Removal of Volatile Component, Coating of Core Body, and Vulcanization of Rubber Composition Layer)

A rubber roller 3 is produced by the same method as for the rubber roller 1 except that the rubber composition 1 prepared is charged directly into the vented extrusion molding apparatus 50 illustrated in FIG. 3 without using the kneading machine 10 illustrated in FIG. 1.

### <Rubber Roller 4>

### (Preparation of Rubber Composition 4)

A rubber composition 4 is prepared by the same method as for the rubber composition 1 except that 5 parts by weight of calcium oxide is added.

### (Removal of Volatile Component, Coating of Core Body, and Vulcanization of Rubber Composition Layer)

A rubber roller 4 is produced by the same method as for the rubber roller 3 except that the rubber composition 4 is used in place of the rubber composition 1.

### <Rubber Roller 5>

### (Preparation of Rubber Composition 5)

A rubber composition 5 is prepared by the same method as for the rubber composition 1 except that epichlorohydrin rubber (trade name: CG102, manufactured by Daiso Co., Ltd., ratio of ethylene oxide: 37 mol %) is used as the epichlorohydrin rubber.

### (Removal of Volatile Component, Coating of Core Body, and Vulcanization of Rubber Composition Layer)

A rubber roller 5 is produced by the same method as for the rubber roller 1 except that the rubber composition 5 is used in place of the rubber composition 1.

### [Measurement of Amount of Volatile Component]

The amount of the volatile component in the unvulcanized rubber composition layer formed on the periphery of the core body in the process for producing the rubber roller is measured by the method described above. The results are shown in Table 1.

### [Evaluation of Rubber Roller]

### <Measurement of Electric Resistance>

An electric resistance value is measured, in a measurement environment of 23° C. and 53% RH, by bringing an electrode roller having a width of 5 mm into contact with the resultant rubber roller and applying a DC voltage of 100 V to the rubber roller while rotating the rubber roller. The results are shown in Table 1.

Also, the same measurement as the above is conducted for the rubber roller after storing the rubber roller in an environment of a temperature 23° C. and a humidity of 53% for 2 weeks, and a change of electric resistance over time is evaluated. The results are shown in Table 1.

### <Confirmation of Presence of Foaming During Vulcanization>

The presence of foaming during vulcanization is confirmed as follows.

Specifically, the roller after vulcanization is cut, and a section is observed with an optical microscope. When bubbles of 100 μm or more are observed, foaming is evaluated as “Yes”, and when bubbles of less than 100 μm are observed, foaming is evaluated as “No”. The results are shown in Table 1.

### <Outer Diameter Growth Over Time>

The resultant rubber roller is stored in an environment of a temperature 28° C. and a humidity of 80% for 2 weeks. The outer diameter of the rubber roller is measured before and after storage by using a laser diameter measuring apparatus (manufactured by Asaka Riken Co., Ltd.: ROLL2000) to determine a difference (value of outer diameter growth). The results are shown in Table 1. The outer diameter of any one of the rubber rollers before storage is 12.0 mm.

When a value of outer diameter growth determined by the above-described method is less than 300 μm, outer diameter growth is evaluated as G1, while when a value of outer diameter growth is 300 μm or more, outer diameter growth is evaluated as G2. The results are shown in Table 1.

### <Surface Smoothness (Ten-Point Mean Roughness Rz)>

The peripheral surface of the resultant rubber roller is measured by using surface roughness meter Surfcom 1400A (manufactured by Tokyo Seimitsu Co., Ltd.) in an environment of a temperature 22° C. and a humidity of 55% according to JIS B0601-1994. The results are shown in Table 1.

TABLE 1

| | | | Comparative | Comparative | Comparative |
|---|---|---|---|---|---|
| | Example 1 | Example 2 | Example 1 | Example 2 | Example 3 |
| Rubber roller | 1 | 2 | 3 | 4 | 5 |
| Amount of ethylene | 59 | 42 | 59 | 59 | 37 |
| oxide (mol %) | | | | | |
| Amount of calcium | 0 | 1 | 0 | 5 | 0 |
| oxide (parts by | | | | | |
| weight) | | | | | |
| Kneading machine | Use | Use | Non-use | Non-use | Use |
| 10 | | | | | |
| Vented extrusion | Use | Use | Use | Use | Use |
| molding apparatus | | | | | |
| 50 | | | | | |
| Amount of volatile | 0.45 | 0.75 | 1.0 | 1.5 | 0.4 |
| component | | | | | |
| (% by weight) | | | | | |
| Electric resistance | 7.5 | 7.8 | 7.5 | 7.5 | 8.2 |
| before storage | | | | | |
| (log Ω) | | | | | |
| Electric resistance | 7.8 | 8.3 | 7.8 | 8.3 | 8.5 |
| after storage (log Ω) | | | | | |
| Presence of foaming | No | No | Yes | No | No |
| Value of outer | 150 | 200 | 220 | 350 | 140 |
| diameter growth (μm) | | | | | |
| Evaluation of outer | G1 | G1 | G1 | G2 | G1 |
| diameter growth | | | | | |
| Ten-point mean | 5.7 | 5.8 | 11.2 | 10.2 | 6.1 |
| roughness (μm) | | | | | |

The results shown in Table 1 reveal that in Examples, outer diameter growth over time is suppressed, while foaming during vulcanization is suppressed as compared with Comparative Examples 1 and 2. Also, it is found that in Examples, the rubber roller having a low electric resistance is produced as compared with Comparative Example 3. In addition, the rubber roller having an electric resistance value of Comparative Example 3 causes image defects such as white spots and the like when used as a charging roller, and thus it is difficult to use as a charging roller.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for producing a rubber roller comprising:
preparing a rubber composition containing epichlorohydrin rubber and a conductive agent, the epichlorohydrin rubber being an epichlorohydrin-ethylene oxide-allyl glycidyl ether ternary copolymer that contains an ethylene oxide-derived structural unit within a range of 40 mol % or more and 60 mol % or less relative to the entire ternary copolymer, and a content of calcium oxide being 1 part by weight or less relative to 100 parts by weight of the epichlorohydrin rubber;
removing a volatile component so that a ratio of the volatile component contained in the rubber composition is 0.8% by weight or less relative to the entire rubber composition;
coating a periphery of a core body with the rubber composition having a volatile component ratio of 0.8% by weight or less to form a rubber composition layer; and
vulcanizing the rubber composition layer under atmospheric pressure to form a rubber layer on the periphery of the core body.

2. The method for producing a rubber roller according to claim 1,
wherein the volatile component is removed so that a ratio of the volatile component contained in the rubber composition is 0.5% by weight or less relative to the entire rubber composition.

3. The method for producing a rubber roller according to claim 1,
wherein the removal of the volatile component includes charging the rubber composition into a closed kneading machine with a vent,
kneading the rubber composition in the kneading machine, and
venting the volatile component through the vent.

4. The method for producing a rubber roller according to claim 3,
wherein venting of the volatile component through the vent is reduced-pressure venting.

5. The method for producing a rubber roller according to claim 1,
wherein the removal of the volatile component includes placing the rubber composition in a closed vessel and evacuating the closed vessel.

6. The method for producing a rubber roller according to claim 1,
wherein venting of the volatile component is repeated two or more times.

7. A rubber composition comprising:
epichlorohydrin rubber that is an epichlorohydrin-ethylene oxide-allyl glycidyl ether ternary copolymer containing an ethylene oxide-derived structural unit within a range of 40 mol % or more and 60 mol % or less relative to the entire ternary copolymer; and
a conductive agent,
wherein a content of calcium oxide is 1 part by weight or less relative to 100 parts by weight of the epichlorohydrin rubber; and
a ratio of a volatile component contained in the rubber composition is 0.8% by weight or less relative to the entire rubber composition.

8. The rubber composition according to claim 7,
wherein a ratio of the volatile component contained in the rubber composition is 0.5% by weight or less relative to the entire rubber composition.
